(19) United States
(12) Patent Application Publication
(10) Pub. No.: US 2013/0208201 A1
(43) Pub. Date: Aug. 15, 2013

(54) DISPLAY DEVICE

(71) Applicants: Eiji Satoh, Osaka-shi (JP); Akio Miyata, Osaka-shi (JP); Kazuhiro Deguchi, Osaka-shi (JP)

(72) Inventors: Eiji Satoh, Osaka-shi (JP); Akio Miyata, Osaka-shi (JP); Kazuhiro Deguchi, Osaka-shi (JP)

(73) Assignee: SHARP KABUSHIKI KAISHA, Osaka-shi, Osaka (JP)

(21) Appl. No.: 13/878,805

(22) PCT Filed: Oct. 6, 2011
(86) PCT No.: PCT/JP2011/073126

§ 371 Date: Apr. 11, 2013

(30) Foreign Application Priority Data
Oct. 12, 2010 (JP) 2010-229742

(51) Int. Cl. G02F 1/1335

(52) U.S. Cl. CPC G02F 1/133617; G02F 1/133528; G02F 1/1335
USPC 349/33; 349/96; 349/61; 349/113; 349/106; 349/84

(57) ABSTRACT

A display device (100A) according to the present invention includes a first substrate (11), a second substrate (21), and a light modulating layer (17) provided between the first substrate (11) and the second substrate (21). The first substrate (11) or the second substrate (21) has a layer (22) provided thereon containing a photochromic compound.

### TECHNICAL FIELD

The present invention relates to a display device, and specifically, a liquid crystal display device.

### BACKGROUND ART

Color liquid crystal display devices widely used today include color filters in correspondence with pixels. Typically, color filters corresponding to three primary colors of light of red (R), green (G) and blue (B) are arrayed in a prescribed pattern in correspondence with pixels. The color display pixels include a plurality of primary color pixels, and typically include pixels of three colors of R, G and B.

In general, a liquid crystal display device includes a pair of substrates and a liquid crystal layer provided therebetween. The above-described plurality of color filters arrayed in accordance with the pixels are formed in either one of the substrates. In a liquid crystal display device, for example, a liquid crystal layer is formed between a TFT substrate including circuit elements such as pixel electrodes, TFTs (Thin Film Transistors) and the like, and a counter substrate including a counter electrode and color filters. The counter substrate including the color filters is often referred to as a “color filter substrate”.

Conventional color filters utilize light absorption by pigments. A liquid crystal display device including such color filters has a low light utilization factor. Specifically, the intensity of light transmitted through the color filters is about ⅓ (one third) of the intensity of light incident on the color filters; namely, the brightness is reduced to half. Especially, a reflection-type liquid crystal display device utilizing external light can provide color display with high visibility in a bright environment but has a problem of not easily providing color display with high visibility in a dark environment.

Color display devices including color liquid crystal display devices which solve this problem are disclosed in Patent Documents 1 through 3.

### CITATION LIST

### Patent Literature

Patent Document 1: Japanese Laid-Open Patent Publication No. 2008-145867
Patent Document 2: Japanese PCT National Phase Laid-Open Patent Publication No. 2004-521396
Patent Document 3: Japanese Laid-Open Patent Publication No. 2007-156497

### SUMMARY OF INVENTION

### Technical Problem

Color filters included in the display device disclosed in Patent Document 1 has a multi-layer structure which includes a layer containing an electrochromic material and an electrode layer for applying a voltage to the electrochromic material, and thus has a small numerical aperture of pixels. As a result, the light transmittance is low, which deteriorates the visibility of a displayed image. In addition, the display device includes a device for applying a voltage to the electrochromic material and a device for controlling the timing to drive the electrochromic material, and therefore has high power consumption.

The present invention made in light of the above points has an object of providing a display device for displaying a highly visible image with low power consumption.

### Solution to Problem

A display device according to the present invention includes a first substrate, a second substrate, and a light modulating layer provided between the first substrate and the second substrate. The first substrate or the second substrate has a photochromic layer provided thereon containing a photochromic compound.

In an embodiment, the light modulating layer is a liquid crystal layer.

In an embodiment, the liquid crystal layer is a scattering-type liquid crystal layer.

In an embodiment, the liquid crystal layer is a PNLC layer or a PDLL layer.

In an embodiment, liquid crystal molecules contained in the liquid crystal layer are aligned uniformly in the absence of voltage.

In an embodiment, the display device further includes a first ultraviolet polarizing plate and a second ultraviolet polarizing plate located closer to a surface on which ultraviolet rays are incident than the first ultraviolet polarizing plate is. The light modulating layer is formed between the first ultraviolet polarizing plate and the second ultraviolet polarizing plate; and the first ultraviolet polarizing plate is located closer to the surface on which the ultraviolet rays are incident than the photochromic layer is.

In an embodiment, the display device further includes a first λ/4 phase plate provided between the first ultraviolet polarizing plate and the light modulating layer; and a second λ/4 phase plate provided between the second ultraviolet polarizing plate and the light modulating layer.

In an embodiment, the display device further includes an ultraviolet modulating layer located closer to a surface on which ultraviolet rays are incident than the photochromic layer is. The ultraviolet modulating layer includes a first ultraviolet polarizing plate, a second ultraviolet polarizing plate, and another liquid crystal layer formed between the first ultraviolet polarizing plate and the second ultraviolet polarizing plate; and liquid crystal molecules contained in the another liquid crystal layer are aligned uniformly in the absence of voltage.

In an embodiment, the display device further includes a first λ/4 phase plate provided between the first ultraviolet polarizing plate and the another liquid crystal layer; and a second λ/4 phase plate provided between the second ultraviolet polarizing plate and the another liquid crystal layer.

In an embodiment, the display device further includes an ultraviolet modulating layer located closer to a surface on which ultraviolet rays are incident than the photochromic layer is. The ultraviolet modulating layer includes an ultraviolet control layer; and intensity of the ultraviolet rays transmitted through the ultraviolet control layer is controlled by application of a voltage to the ultraviolet control layer.

In an embodiment, the ultraviolet control layer is formed of a guest-host liquid crystal material containing an ultraviolet dichroic dye.

In an embodiment, the ultraviolet control layer is an electrowetting layer containing an ultraviolet absorbing colorant.

In an embodiment, the light modulating layer is formed closer to a surface on which ultraviolet rays are incident than the photochromic layer is; and the light modulating layer is formed of a guest-host liquid crystal material containing an ultraviolet dichroic dye.

In an embodiment, the display device further includes an ultraviolet absorbing plate and an ultraviolet output layer. The photochromic layer is formed between the ultraviolet absorbing plate and the ultraviolet irradiation layer; and ultraviolet rays which are output from the ultraviolet output layer are directed toward the photochromic layer.

In an embodiment, the display device further includes an ultraviolet absorbing plate and an ultraviolet output layer. The ultraviolet output layer is formed between the ultraviolet absorbing plate and the photochromic layer; and ultraviolet rays which are output from the ultraviolet output layer are directed toward the photochromic layer.

In an embodiment, the display device further includes a backlight unit including an ultraviolet light source. Ultraviolet rays which are emitted from the backlight unit are directed toward the photochromic layer.

In an embodiment, the display device further includes an ultraviolet absorbing layer. The photochromic layer is formed between the ultraviolet absorbing plate and the backlight unit.

In an embodiment, the display device is a see-through-type display device; and the first substrate and the second substrate both have a layer provided thereon containing the photochromic compound.

In an embodiment, the display device further includes a reflective film.

In an embodiment, the display device further includes a color filter layer. The photochromic layer is stacked on the color filter layer as seen in a direction normal to a display plane of the display device. The color filter layer is preferably formed between the light modulating layer and the photochromic layer.

### Advantageous Effects of Invention

The present invention provides a display device capable of displaying a highly visible image even in a relatively dark environment with low power consumption.

### BRIEF DESCRIPTION OF DRAWINGS

FIGS. 1(a) through 1(e) are schematic cross-sectional views provided to describe a display device 100A in an embodiment according to the present invention.

FIGS. 2(a) through 2(b) are schematic cross-sectional views provided to describe the display device 100A.

FIG. 3 is a schematic cross-sectional views provided to describe a display device 100A including a photochromic layer 22 in another embodiment according to the present invention.

FIGS. 4(a) and 4(b) are schematic cross-sectional views provided to describe a display device 100B in another embodiment according to the present invention.

FIGS. 5(a) and 5(b) are schematic cross-sectional views provided to describe a display device 100C in still another embodiment according to the present invention.

FIGS. 6(a) and 6(b) are schematic views provided to describe a path of ultraviolet rays for putting a layer 22 containing a photochromic compound into a color-developed state and a color-disappeared state.

FIGS. 7(a) and 7(b) are schematic cross-sectional views provided to describe a display device 100D in still another embodiment according to the present invention.

FIGS. 8(a) through 8(d) are schematic cross-sectional views provided to describe a display device 100E in still another embodiment according to the present invention.

FIG. 9 is a schematic cross-sectional view provided to describe a display device 100F in still another embodiment according to the present invention.

FIG. 10 is a schematic cross-sectional view provided to describe a display device 100G in still another embodiment according to the present invention.

FIG. 11 is a schematic cross-sectional view provided to describe a display device 100H in still another embodiment according to the present invention.

FIGS. 12(a) and 12(b) are schematic cross-sectional views provided to describe a display device 100I in still another embodiment according to the present invention.

FIGS. 13(a) and 13(b) are schematic cross-sectional views provided to describe a display device 100J in still another embodiment according to the present invention.

FIGS. 14(a) through 14(c) are schematic cross-sectional views provided to describe a display device 100K in still another embodiment according to the present invention.

### DESCRIPTION OF EMBODIMENTS

Hereinafter, display devices 100A through 100K in embodiments according to the present invention will be described with reference to the drawings. The display devices 100A through 100K in the embodiments according to the present invention are liquid crystal display devices. Each of these liquid crystal display device is of a reflection type, a transmission type or a see-through type.

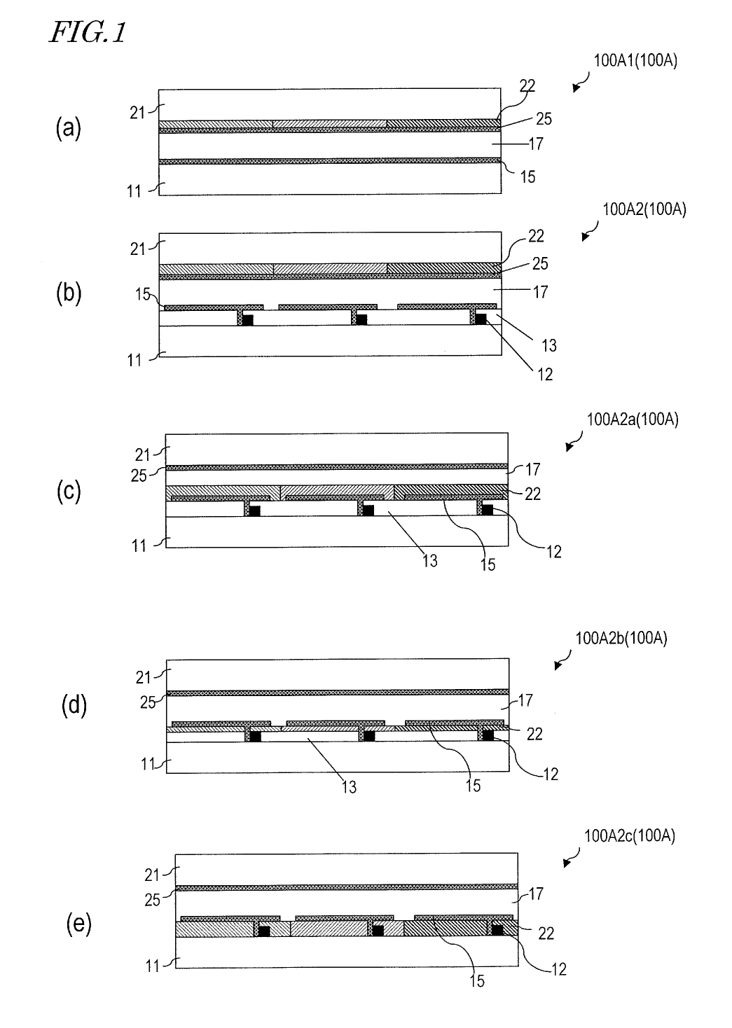

With reference to FIGS. 1 through 3, the display device 100A in an embodiment according to the present invention will be described.

FIGS. 1(a) through 1(e) are schematic cross-sectional views of the display device 100A. The display device 100A is a reflection-type liquid crystal display device.

A display device 100A1 shown in FIG. 1(a) includes a first substrate (e.g., glass substrate) 11, a second substrate (e.g., glass substrate) 21 facing the first substrate 11, and a light modulating layer 17 provided between the first substrate 11 and the second substrate 21. On the first substrate 11 and the second substrate 21, transparent electrodes 15 and 25 formed of, for example, ITO (Indium Tin Oxide) are respectively formed. The light modulating layer 17 is provided between the transparent electrodes 15 and 25. Between the second substrate 21 and the light modulating layer 17, a layer 22 containing a photochromic compound (hereinafter, referred to as “photochromic layer”) is provided. In the case where, for example, the display device 100A1 is a TFT-type liquid crystal display device, the transparent electrode 15 or 25 may be formed such that a plurality of such electrode are provided in correspondence with pixels in a one-to-one correspondence. In the case where the display device 100A1 is a passive liquid crystal display device, the transparent electrodes 15 and 25 may be formed in a stripe pattern.

A display device 100A2 shown in FIG. 1(b) includes a first substrate 11, a second substrate 21 facing the first substrate 11, and a light modulating layer 17 provided between the first substrate 11 and the second substrate 21. The display device 100A2 includes, switching devices 12 such as, for example, TFTs, an insulating layer 13, and transparent electrodes 15 formed on the insulating layer 13. These elements are formed on the first substrate 11. The transparent electrodes 15 are provided in correspondence with the pixels in a one-to-one correspondence. The display device 100A2 includes a photochromic layer 22 and a transparent electrode 25 on the second substrate 21. Between the transparent electrodes 15 and the transparent electrode 25, a light modulating layer 17 is provided. In the case where, for example, the display device 100A2 is an IPS (In-Plain Switching)-mode or FFS (Fringe Field Switching)-mode liquid crystal display device, the transparent electrode 25 may be omitted.

A display device 100A2a shown in FIG. 1(c) is different from the display device 100A2 in that the photochromic layer 22 is formed between the transparent electrodes 15 formed above the first substrate 11 and the light modulating layer 17, instead of between the second substrate 21 and the light modulating layer 17. A display device 100A2b shown in FIG. 1(d) and a display device 100A2c shown in FIG. 1(e) each include a photochromic layer 22 between the transparent electrodes 15 and the first substrate 11. In the display device 100A2c, the photochromic layer 22 also acts as an insulating layer 13.

Although not shown in FIGS. 1(a) through 1(e), each display device 100A includes a reflective plate for reflecting visible light is provided on the side of the first substrate 11 opposite to the light modulating layer 17, and thus can provide display in a reflection mode by use of light incident on the second substrate 21.

The display device 100A in this embodiment includes the photochromic layer 22, and utilizes that the photochromic layer 22 is switched between a colorless transparent state and a color-developed state in accordance with whether or not being irradiated with light (e.g., ultraviolet light) in the presence of, for example, visible light.

As the photochromic compound, naphthospirooxazine shown in chemical formula 1 is used, for example.

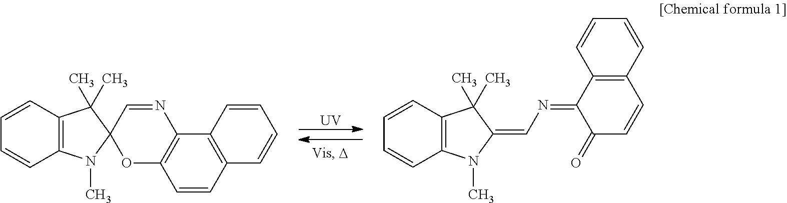

The compound shown in chemical formula 1 is colorless in a closed ring structure on the left. When being irradiated with ultraviolet rays, the compound is put into an open ring structure on the right and color-developed (e.g., blue). In the state of not being irradiated with ultraviolet rays, the compound returns to the closed ring structure from the open ring structure by thermal energy. Such a property is referred to as “photochromic property”.

The photochromic compound is not limited to naphthospirooxazine, and may be any material exhibiting a photochromic property with no specific limitation. The photochromic compound may be an inorganic or metal material. An organic material may be used from the viewpoint of the width of range of material selection. In general, the photochromic compound is put into a first state when being irradiated with light in the range from ultraviolet light to blue light, and is put into a second state when being heated, irradiated with visible light or oxidized by oxygen. The first state and the second state may be respectively a color-developed state and a color-disappeared state, or vice versa. Photochromic materials are conventionally developed as optical recording materials, and various materials are known. Usable organic photochromic materials include spiropyran, spirooxazine, diarylethene, fulgide, hemithioindigo, hexaarylbisimidazole, chalcone derivatives and the like, and a substance obtained as a result of each of these substances being bonded to a polymer. Usable inorganic photochromic materials include silver halide, tungsten oxide, molybdenum oxide, niobium oxide, silver bromide, other metal oxides, and metal complexes.

The photochromic layer 22 is formed by substantially the same method as for forming a known color filer layer. For example, a photochromic compound dispersed in an acrylic resin, a polyimide resin, an epoxy resin or the like is used. In the case where areas of the photochromic layer 22 are to be formed in prescribed areas, or in correspondence with the pixels in a one-to-one correspondence, the photochromic layer is formed on a substrate by a photolithography method or an inkjet method. As the photochromic compound to be mixed with a resin, a single compound or a mixture of a plurality of compounds may be used for each color area.

As shown in FIG. 1, a plurality of colors (e.g., R, G, B) are provided for the pixels in a one-to-one correspondence so as to provide various colors. Alternatively, a single color may be formed uniformly, a single color may be formed in a certain area in the display device, or a plurality of colors are formed in different areas in the display device, so as to provide monochromatic display or provide area color display.

Between the areas of different colors of the photochromic layer 22 or at positions corresponding to gaps between the pixels, a black matrix layer (not shown) formed of a metal or resin may be provided.

The light modulating layer 17 is a scattering-type liquid crystal layer. Among various scattering-type liquid crystal layers, the light modulating layer 17 is a normal-mode PNLC (Polymer Network Liquid Crystal) layer or a PDLC (Polymer Dispersed Liquid Crystal) layer, which are put into a scattered state when being supplied with a low voltage and are made transparent when being supplied with a high voltage. Among various scattering-type liquid crystal layers, the light modulating layer 17 may be a reverse-mode PNLC layer or PDLC layer, which are made transparent when being supplied with a low voltage and are put into a scattered state when being supplied with a high voltage. Alternatively, the light modulating layer 17 may be a guest-host-type liquid crystal layer, a liquid crystal layer containing liquid crystal molecules aligned uniformly in the absence of voltage, or a cholesteric liquid crystal layer (e.g., broad band cholesteric liquid crystal layer having a selective-reflection wavelength set to a wide wavelength range, or cholesteric liquid crystal layer having a selective-reflection wavelength set to an infrared range and providing display by scattering or transmitting light). Still alternatively, the light modulating layer 17 may be a liquid or gas electrophoretic layer, an electrowetting (EW) layer, a mechanical shutter layer or the like. The “liquid crystal layer containing liquid crystal molecules aligned uniformly in the absence of voltage” refers to, for example, a liquid crystal layer containing liquid crystal molecules aligned in parallel in the absence of voltage, a liquid crystal layer containing liquid crystal molecules aligned vertically in the absence of voltage, or a liquid crystal layer containing TN (Twisted Nematic)-aligned liquid crystal molecules; namely, refers to a liquid crystal layer which is not a liquid crystal layer divided into minute domains in, for example, a focalconic state.

The reverse-mode PNLC layer or PDLC layer is formed by a combination of a polymer which does not have refractive index anisotropy and an n-type liquid crystal material. A vertical alignment film is provided on each of the first substrate 11 and the second substrate 12 in contact with the PNLC layer or the PDLC layer. Alternatively, a vertical alignment film may be formed on each of the first substrate 11 and the second substrate 12 in contact with the PNLC layer or the PDLC layer, and the PNLC layer or the PDLC layer may be formed of a combination of a polymer having refractive index anisotropy and an n-type liquid crystal material. Still alternatively, a horizontal alignment film may be formed on each of the first substrate 11 and the second substrate 12 in contact with the PNLC layer or the PDLC layer, and the PNLC layer or the PDLC layer may be formed of a combination of a polymer having refractive index anisotropy and a p-type liquid crystal material. (See Table 1.)

In the case where the light modulating layer 17 is, for example, a PDLC layer, a PNLC layer, a cholesteric liquid crystal layer or the like, dark display can be provided by forming a black or dark-color light absorbing layer on, for example, the insulating layer 13 or on the side of the first substrate 11 opposite to the light modulating layer 17.

In the case where the display device 100A is a liquid crystal display device of, for example, a TN mode, an ISP mode or the like, a polarizing plate is used. A λ/4 phase plate or any other phase plate may also be used. The location of the polarizing plate or the phase plate may be determined by a conventional method.

In the display devices 100A1, 100A2 and 100A2a, the transparent electrode(s) 15 may be replaced with an electrode(s) formed of a metal material reflecting visible light (e.g., Al (aluminum) or Ag (silver)). In this case, the reflective plate mentioned above may not be used.

FIGS. 1(b) through 1(e) each show an active driving system display device having the switching devices 12, but a display device according to the present invention may be a passive driving system display device having no switching device 12.

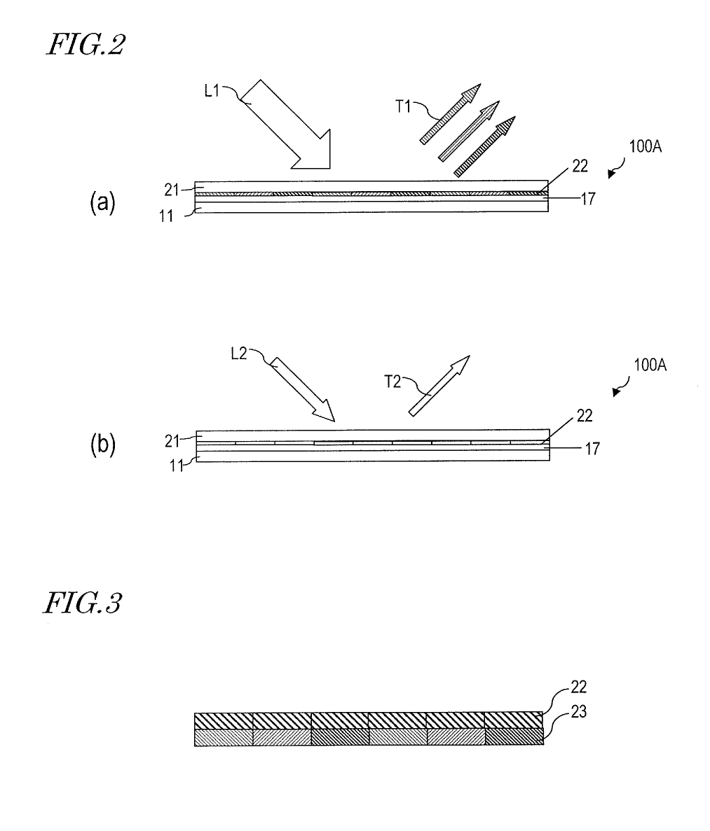

In an environment shown in FIG. 2 where sunlight L1 is directed, for example, outdoors during the daytime, the photochromic layer 22 is irradiated with ultraviolet rays contained in the sunlight L1. Therefore, the photochromic layer 22 is put into a color-developed state, and light T1 used to form an image displayed on the display device 100A is chromatic light (colored light) (see FIG. 2(a)). By contrast, in a dark environment, for example, during the nighttime or indoors, the photochromic layer 22 is not irradiated with ultraviolet rays. Therefore, the photochromic layer 22 is put into a color-disappeared state, and light T2 used to form an image displayed on the display device 100A is colorless light (see FIG. 2(b)). The time required to change the photochromic layer 22 from the color-developed state to the color-disappeared state, and from the color-disappeared state to the color-developed state, depends on the type of the photochromic compound.

In this manner, the display device 100A including the photochromic layer 22 provides full-color display, monochromatic display, or area color display in a bright environment. In a dark environment, the photochromic layer 22 does not absorb light, and therefore the display device 100A can provide black-and-white display having a high brightness. Therefore, for example, a reflection-type liquid crystal display device for providing display utilizing only external light can provide color display containing color information in accordance with the irradiation environment and also display having a high brightness with the visibility being considered important, with no need to have a control circuit.

As shown in FIG. 3, the photochromic layer 22 may be stacked on, for example, a conventional color filer layer 23 having a pigment dispersed therein, as seen in a direction normal to a display plane of the display device 100A. Owing to such a structure, when the photochromic layer 22 is in a color-developed state, display with a high color purity is provided; whereas when the photochromic layer 22 is in a color-disappeared state, display is provided with the brightness being considered more important than the color purity.

In the case where the photochromic layer 22 is closer to a surface on which the ultraviolet rays are incident than the light modulating layer 17 is, a photochromic compound which absorbs light having a wavelength outside the ultraviolet range may be used so as to prevent deterioration of the light modulating layer (e.g., PDLC layer, etc.) 17 by the ultraviolet rays.

Hereinafter, the display devices 100B through 100K in other embodiments according to the present invention, which provide the same effects as those of the display device 100A will be described. Common elements among the display devices will bear identical reference signs, and repetition of the same descriptions will be avoided.

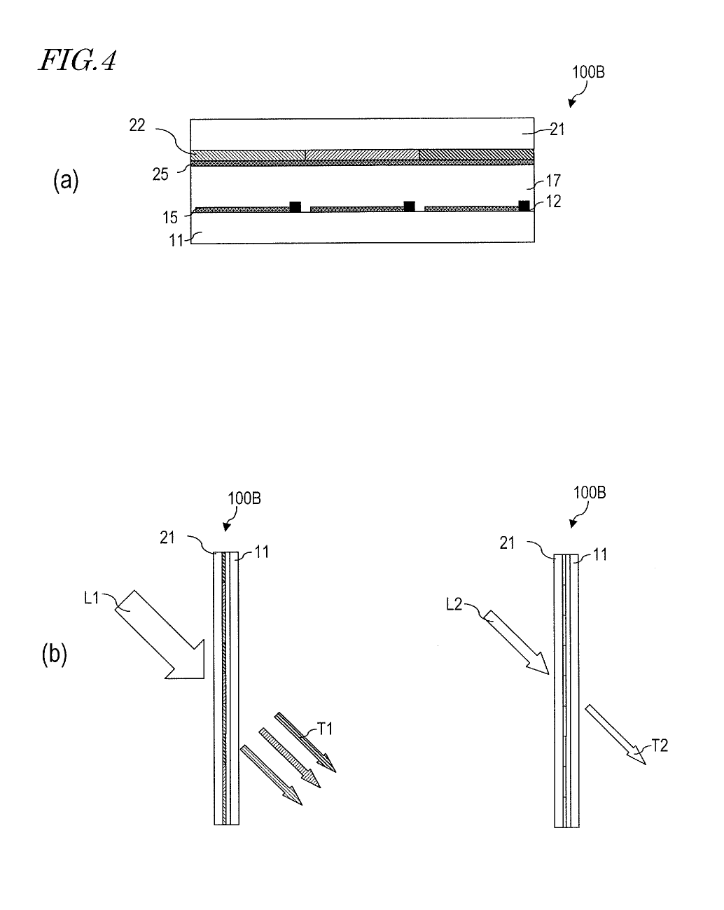

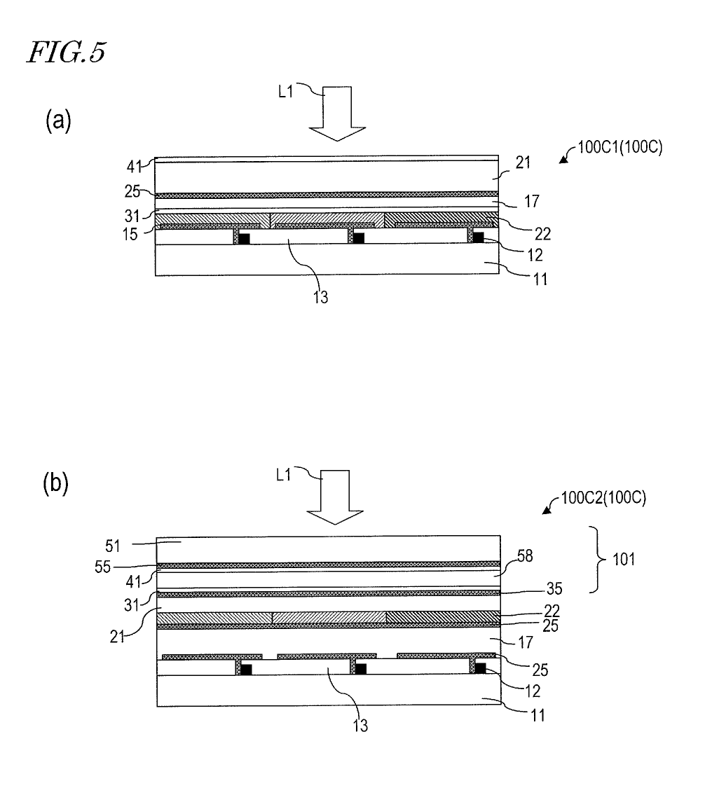

FIGS. 4(a) and 4(b) are schematic cross-sectional views provided to describe the display device 100B in an embodiment according to the present invention.

The display device 100B show in FIGS. 4(a) and 4(b) is a see-through-type liquid crystal display device. A see-through-type liquid crystal display device does not include a backlight unit or a reflective plate. Therefore, a viewer can see the background through the display device 100B as well as the displayed image.

The display device 100B shown in FIG. 4(a) has substantially the same structure as that of the display device 100A2a described above. Unlike the display device 100A2a, the display device 100B does not include, for example, the backlight unit or the reflective plate. Although not shown, the display device 100B may include the insulating layer 13, which is also included in the display device 100A2.

In the see-through-type liquid crystal display device, the photochromic layer 22 may be provided on both of the first substrate 11 and the second substrate 12 (this structure is not shown). Owing to this structure, regardless of whether the sunlight is directed toward the first substrate 11 or the second substrate 12, display having a high color purity can be obtained.

In the case where the light modulating layer 17 is a PDLC layer or a PNLC layer, the PDLC layer or the PNLC layer is formed by irradiation with ultraviolet rays. In this case, the substrate on which the photochromic layer 22 is not formed may be irradiated with UV so that the PDLC layer or the PNLC layer can be formed efficiently and characteristics of the pixels of different colors can be made uniform. In the case where the photochromic layer 22 is formed on both of the first substrate 11 and the second substrate 12, the PDLC layer or the PNLC layer may be formed by irradiation with, for example, light of a wavelength which is absorbed at substantially the same absorbance by the areas of different colors of the photochromic layer 22. Thus, characteristics of the pixels of different colors can be made uniform.

Referring to FIG. 4(b), in an environment in which the sunlight L1 is directed, for example, outdoors during the daytime, the light T1 used to form an image displayed on the display device 100B is chromatic light (colored light). By contrast, in a dark environment, for example, during the nighttime or indoors, the light T2 used to form an image displayed on the display device 100B is colorless.

FIGS. 5(a) and 5(b) are schematic cross-sectional views provided to describe the display device 100C in an embodiment according to the present invention. The display device 100C is a reflection-type liquid crystal display device.

A display device 100C1 shown in FIG. 5(a) includes ultraviolet polarizing plates 31 and 41 in addition to the elements of the display device 100A2a described above.

The ultraviolet polarizing plates 31 and 41 are provided closer to the surface on which the ultraviolet rays L1 are incident than the photochromic layer 22 is. The ultraviolet polarizing plate 31 is provided, for example, between the photochromic layer 22 and the light modulating layer 17. The ultraviolet polarizing plate 41 is provided, for example, on the ultraviolet rays L1 incidence side of the second substrate 21. The light modulating layer 17 is formed between the ultraviolet polarizing plate 31 and the ultraviolet polarizing plate 41.

It is preferable that the light modulating layer 17 is, for example, a normal-mode PNLC or PDLC layer, a reverse-mode PNLC or PDLC layer, a cholesteric liquid crystal layer providing display by scattering or transmitting light, or a liquid crystal layer containing liquid crystal molecules aligned uniformly in the absence of voltage. The “liquid crystal layer containing liquid crystal molecules aligned uniformly in the absence of voltage” refers to, for example, a liquid crystal layer containing liquid crystal molecules aligned in parallel or a liquid crystal layer containing TN (Twisted Nematic)-aligned liquid crystal molecules; namely, refers to a liquid crystal layer which is not a liquid crystal layer divided into minute domains in, for example, a focalconic state. In the case where the light modulating layer 17 is a cholesteric liquid crystal layer having a selective-reflection wavelength set to an infrared range and providing display by scattering or transmitting light, such a liquid crystal layer is switchable between a focalconic state in which the domains are scattered randomly and a homeotropic state in which the liquid crystal molecules are aligned vertical to the substrates 11 and 21 and thus provides display.

In the case where the light modulating layer 17 is a liquid crystal layer, retardation (R=Δn×d) of the liquid crystal layer merely needs to be greater than 0, and is preferably 150 nm or greater and 200 nm or less. A reason for this is that the retardation in such an area increases the transmittance of ultraviolet rays through the ultraviolet polarizing plate 31. Δn represents the effective refractive index anisotropy in the state where, for example, a polymer or the like is mixed in the liquid crystal layer. d represents the thickness of the liquid crystal layer (cell thickness). Specifically, Δn is preferably 0.01 or greater and 0.2 or less. d is preferably 1 μm or greater and 15 μm or less.

It is preferable that the ultraviolet polarizing plates 31 and 41 are structured so as to make ultraviolet rays transmitted therethrough linearly polarized light or circularly polarized light and so as to have a high transmittance for visible light. More preferably, the ultraviolet polarizing plates 31 and 41 have a transmittance for visible light of 90% or higher. The wavelength of ultraviolet rays to be polarized is preferably in the range of 300 nm or longer and 400 m or shorter in consideration of the absorbance of glass for ultraviolet rays.

The ultraviolet polarizing plates 31 and 41 are formed of a material having absorption anisotropy for, for example, ultraviolet rays. The ultraviolet polarizing plates 31 and 41 are formed by, for example, forming an azo-based compound on the first substrate 11 and the second substrate 12 and then directing polarized ultraviolet rays to align the alignment direction of the azo-based compound. Alternatively, a polymerizable azo-based compound may be used, so that while the azo-based compound is aligned or after the azo-based compound is aligned, the azo-based compound is polymerized to fix the alignment. Still alternatively, the ultraviolet polarizing plates 31 and 41 may be each formed of a wire grid or the like including metal lines arrayed regularly.

Now, a locating arrangement of the ultraviolet polarizing plates 31 and 41 will be described. In the case where a liquid crystal layer 58 is a normal-mode PNLC layer or PDLC layer or a cholesteric liquid crystal layer providing display by scattering or transmitting light, the two ultraviolet polarizing plates 31 and 41 are located such that polarization axes thereof make a degree of 90 degrees with respect to each other. In the case where the liquid crystal layer 58 is a reverse-mode PNLC layer or PDLC layer, the two ultraviolet polarizing plates 31 and 41 are located such that the photochromic layer 22 is not irradiated with ultraviolet rays when the reverse-mode PNLC layer or PDLC layer is in a transparent state, although this arrangement may be varied depending on the alignment direction of the liquid crystal molecules. Namely, the ultraviolet polarizing plates 31 and may be located such that the photochromic layer 22 is irradiated with, or not irradiated with, ultraviolet rays when a voltage is applied to the light modulating layer 17.

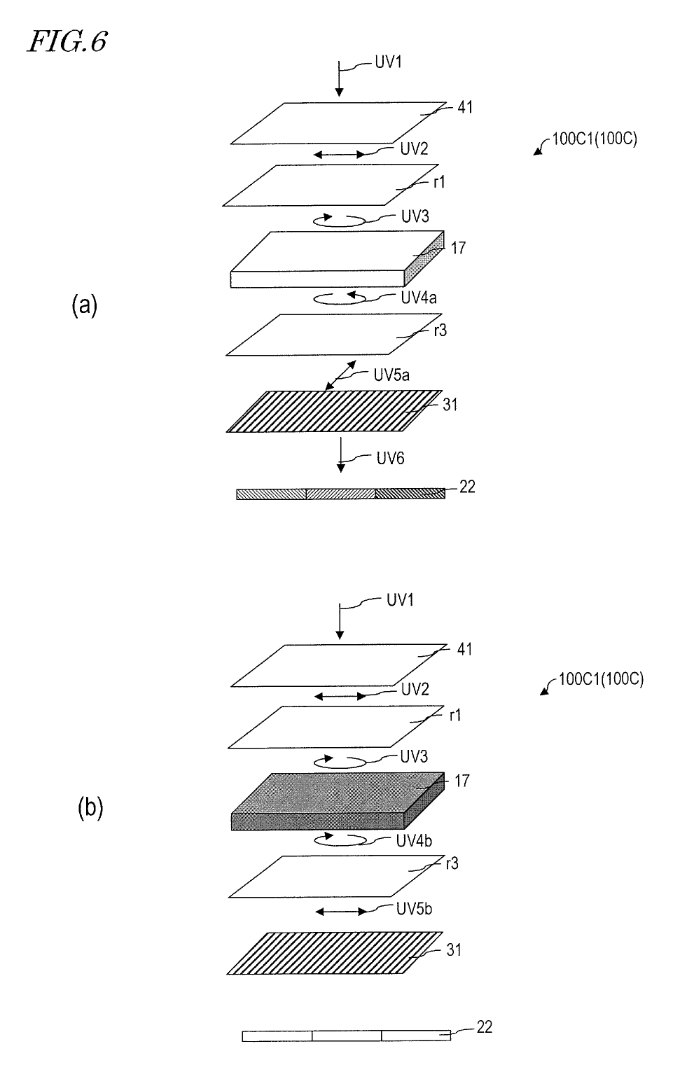

In the case where the ultraviolet rays transmitted through the ultraviolet polarizing plates 31 and 41 become linearly polarized light, a λ/4 phase plate may be provided on the light modulating layer 17 side of each of the ultraviolet polarizing plates 31 and 41 so as to control the ultraviolet rays directed toward the photochromic layer 22 to be circularly polarized light. The principle of controlling the irradiation of the photochromic layer 22 with ultraviolet rays will be described later with reference to FIGS. 6(a) and 6(b).

A display device 100C2 shown in FIG. 5(b) includes an ultraviolet modulating layer 101 having an ultraviolet modulating function in addition to the elements of the display device 100A2a. The ultraviolet modulating layer 101 is provided on the ultraviolet rays L1 incidence side of the second substrate 21.

The ultraviolet modulating layer 101 includes the second substrate 21, a third substrate 51 facing the second substrate 21, and a liquid crystal layer 58 provided between the second substrate 21 and the third substrate 51. The second substrate 21 has a transparent electrode 35 and an ultraviolet polarizing plate 31 provided thereon. The transparent electrode 35 is formed of ITO or the like, and the ultraviolet polarizing plate 31 is formed on the transparent electrode 35. The third substrate 51 has a transparent electrode 55 and an ultraviolet polarizing plate 41 provided thereon. The transparent electrode 55 is formed on the liquid crystal layer 58 side of the third substrate 51 and is formed of ITO or the like. The ultraviolet polarizing plate 41 is provided on the liquid crystal layer 58 side of the transparent electrode 55. As described above, a λ/4 phase plate may be provided on the light modulation 17 side of each of the ultraviolet polarizing plates 31 and 41 so as to control the ultraviolet rays directed toward the photochromic layer 22 to be circularly polarized light.

It is preferable that the liquid crystal layer 58 include liquid crystal molecules aligned uniformly in the absence of voltage. In this case, any type of light modulating layer 17 which can act as the light modulating layer 17 in the display device 100A as described above is usable with no specific limitation.

A voltage is applied to the liquid crystal layer 58 to control the irradiation of the photochromic layer 22 with ultraviolet rays.

Now, with reference to FIGS. 6(a) and 6(b), the display device 100C1 including the ultraviolet polarizing plates 31 and 41 and λ/4 phase plates r1 and r3 will be described.

FIGS. 6(a) and 6(b) are schematic views provided to describe display provided by the display device 100C1 in which the light modulating layer 17 is a normal-mode PNLC layer, and the λ/4 phase plates r1 and r3 for ultraviolet rays are respectively located on the light modulating layer 17 side of the ultraviolet polarizing plates 31 and 41.

As shown in FIG. 6(a), when the light modulating layer 17 is supplied with no voltage, the liquid crystal molecules are substantially uniformly in each of domains divided by the action of the polymer. The display device 100C1 is not a scattering-type display device which is switchable between a state where the light is scattered and a state where the light is transmitted, but is an ECB (Electrically Controllable Birefringence)-mode display device. A structure and a method for producing a PNLC layer capable of providing display in the ECB mode are described in International Publication No. 2009/069249. The entire disclosure of International Publication No. 2009/069249 is incorporated herein by reference. In the above-mentioned state, retardation occurs in a thickness direction of the light modulating layer 17. The thickness and the liquid crystal material of the light modulating layer 17 are designed such that the retardation thereof is, for example, 190 nm. In the case where, for example, the ultraviolet polarizing plates 31 and 41 have absorption anisotropy for light having a wavelength of 380 nm, ultraviolet rays UV1 incident on the ultraviolet polarizing plate 41 become linearly polarized light UV2 by the ultraviolet polarizing plate 41. The linearly polarized light UV2 is incident on the λ/4 phase plate r1, and is transmitted through the λ/4 phase plate r1 to become circularly polarized light UV3. The circularly polarized light UV3 is incident on the light modulating layer 17, and is transmitted through the light modulating layer 17 to become circularly polarized light UV4a directed in the opposite direction to the circularly polarized light UV3. Next, the circularly polarized light UV4a is incident on the λ/4 phase plate r3, and is transmitted through the λ/4 phase plate r3 to become linearly polarized light UV5a. The ultraviolet polarizing plate 31 is located so as to transmit the linearly polarized light UV5a, and therefore the linearly polarized light UV5a is transmitted through the ultraviolet polarizing plate 31. As a result, linearly polarized light UV6 having a wavelength of 380 nm is directed toward the photochromic layer 22, and thus the photochromic layer 22 is put into a color-developed state.

By contrast, as shown in FIG. 6(b), when the light modulating layer 17 is supplied with a voltage, the liquid crystal molecules are aligned in the thickness direction of the light modulating layer 17. Therefore, the light modulating layer 17 is put into a state where polarized light vertically incident thereon is not provided with a phase contrast (retardation is 0 (zero)). In this case, as described above, ultraviolet rays (UV1 through UV3) are sequentially incident on, and transmitted through, the ultraviolet polarizing plate 41 and the λ/4 phase plate r1. Then, ultraviolet rays UV3 are incident on, and transmitted through, the light modulating layer 17. Ultraviolet rays UV4b obtained by the ultraviolet rays UV3 being transmitted through the light modulating layer 17 are not changed in the polarization state from the ultraviolet rays UV3, and remain circularly polarized light directed in the same direction as the ultraviolet rays UV3. Then, the circularly polarized light UV4 is incident on the λ/4 phase plate r3, and ultraviolet rays UV5b are output from the λ/4 phase plate r3 as linearly polarized light having a polarization direction different by 90° from that of the ultraviolet rays UV5a. The ultraviolet rays UV5a are not transmitted through the ultraviolet polarizing plate 31 and thus is not directed toward the photochromic layer 22. Therefore, the photochromic layer 22 is put into a color-disappeared state. The display device 100C1 merely needs to have such a principle of controlling the irradiation of the photochromic layer 22 with ultraviolet rays. Thus, color filters of the display device 100C1 may be located as in the display device 100A2b or 100A2c. The display device 100C1 may be modified to a scattering-type display device switchable between a state where the light is scattered and a state where the light is transmitted.

As described above, the display device 100C having such a structure can provide, for example, full-color display in a bright environment and display having a high brightness in a dark environment. Even in a bright environment, the photochromic layer 22 is in a color-disappeared state in an area with no image or character information. Therefore, in the case where, for example, the display device 100C includes a reflective electrode having a mirror surface, a mirror image having a high reflectance is obtained in an area other than the area with no image or character information.

When it is wished to use the display device 100C as a mirror, the entirety of the light modulating layer 17 may be put into a vertical alignment state. As a result, the photochromic layer 22 is also put into a color-disappeared state at the same time, and the display device 100C can be used as a mirror having a high reflectance.

In the case where the light modulating layer 17 contains liquid crystal molecules aligned uniformly in the absence of voltage, a part thereof where ultraviolet rays are transmitted is colored and the remaining part thereof acts as a mirror. Thus, stained glass-like display is provided. In the display device 100C2, the liquid crystal layer 58 may be a liquid crystal layer containing liquid crystal molecules aligned uniformly in the absence of voltage, and the light modulating layer 17 may be a PNLC layer or a PDLC layer. In this case, color display can be provided in a bright environment, whereas display having a high brightness can be provided in a dark environment or in a black-and-white display. When it is wished to use the display device 100C2 as a mirror, the display device 100C2 can act as a mirror having a high reflectance. By adjusting a voltage to be applied to the liquid crystal layer, containing liquid crystal molecules aligned uniformly in the absence of voltage, the balance between the chroma and brightness can be adjusted. Even when the display device 100C2 has the above-described stacking structure, active elements such as TFTs or the like for driving the liquid crystal layer containing liquid crystal molecules aligned uniformly in the absence of voltage may be used, so that an area for displaying an image provides color display and the remaining area acts as a mirror having a high reflectance.

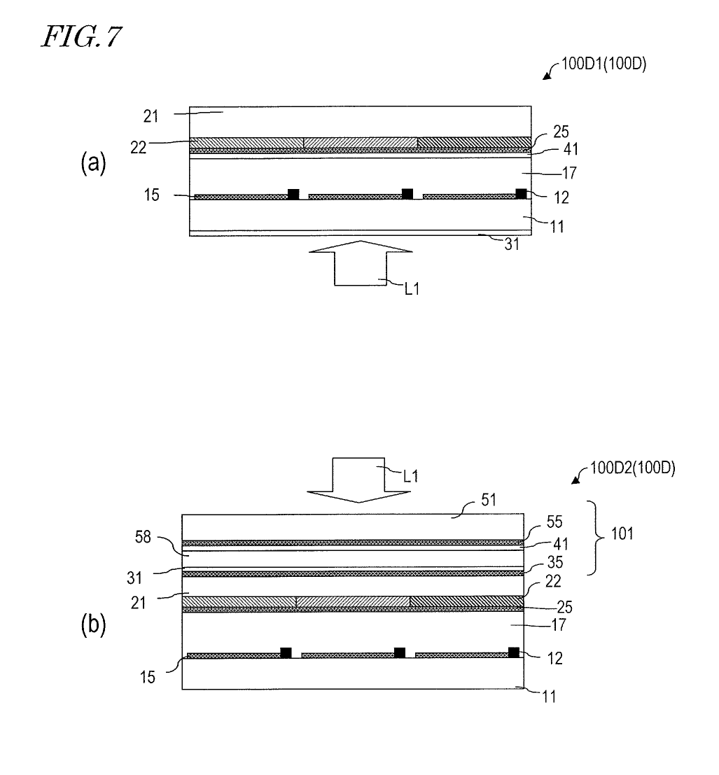

Now, with reference to FIG. 7, the display device 100D in an embodiment according to the present invention will be described. The display device 100D is a see-through-type liquid crystal display device.

Display devices 100D1 and 100D2 respectively shown in FIGS. 7(a) and 7(b) have substantially the same structure as that of the display device 100B, and further include ultraviolet polarizing plates 31 and 41 as described above located closer to the surface on which the ultraviolet rays L1 are incident than the photochromic layer 22 is. The display device 100D2 includes an ultraviolet modulating layer 101 on the ultraviolet rays L1 incidence side of the second substrate 21, like in the display device 100C2.

As described above regarding the display device 100C, a voltage is applied to the ultraviolet polarizing plates 31 and 41 and the light modulating layer 17 (or the liquid crystal layer 58) to control the irradiation of the photochromic layer 22 with ultraviolet rays and thus control the photochromic layer 22 to be in a color-developed state or a color-disappeared state.

The display device 100D can provide full-color display in, for example, a bright environment with sunlight, and provide display having a high brightness in, for example, a dark environment. Even in the bright environment with sunlight, the photochromic layer 22 is in a color-disappeared state in an area with no displayed image or character information. Therefore, an area with no displayed image or character information is transparent. Thus, the display device 100D can display an image or character information as floating in midair. In the case where, for example, the display device 100D1 is located as a window and it is wished to use the display device 100D1 as a transparent window, the entirety of the light modulating layer 17 may be put into a vertical alignment state. As a result, the photochromic layer is also put into a color-disappeared state at the same time, and the display device 100D1 can be used as a window having a high transmittance.

In the display device 100D1, the light modulating layer 17 may be a liquid crystal layer containing liquid crystal molecules aligned uniformly in the absence of voltage. In this case, a part thereof where ultraviolet rays are transmitted is colored and the remaining part thereof is transparent. Thus, stained glass-like display is provided.

In the display device 100D2, the liquid crystal layer 58 may be a liquid crystal layer containing liquid crystal molecules aligned uniformly in the absence of voltage, and the light modulating layer 17 may be a PNLC layer or a PDLC layer. In this case, color display can be provided in a bright environment with sunlight, whereas display having a high brightness can be provided in a dark environment or in a black-and-white display. By adjusting a voltage to be applied to the liquid crystal layer, containing liquid crystal molecules aligned uniformly in the absence of voltage, the balance between the chroma and brightness can be adjusted. The liquid crystal layer 58 may be a liquid crystal layer containing liquid crystal molecules aligned uniformly in the absence of voltage, and active elements may be used to drive the liquid crystal layer 58. In this case, only an area for displaying an image provides color display and the remaining area acts as a window having a high transmittance.

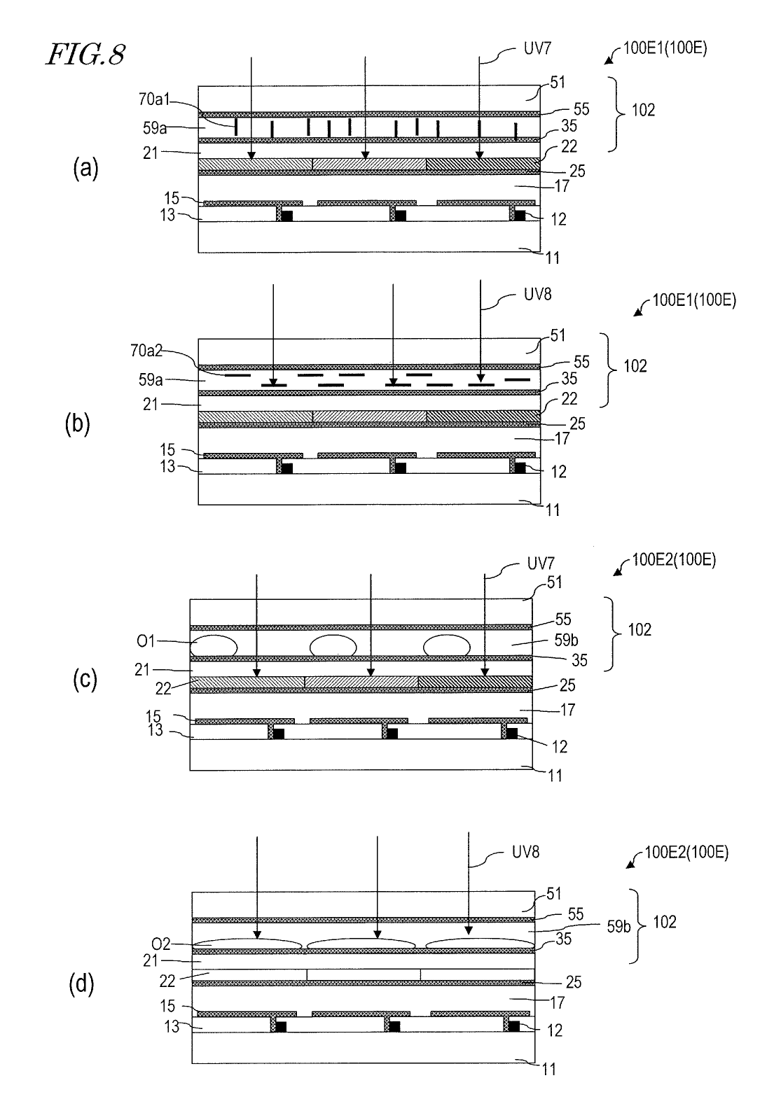

Now, with reference to FIGS. 8(a) through 8(d), the display device 100E in another embodiment according to the present invention will be described. The display device 100E is a reflection-type liquid crystal display device.

Display devices 100E1 and 100E2 displayed in FIGS. 8(a) through 8(d) each have a structure including an ultraviolet modulating layer 102 having an ultraviolet modulating function in addition to the elements of the display device 100A2. The ultraviolet modulating layer 102 is provided on the ultraviolet rays L1 incidence side.

The ultraviolet modulating layer 102 includes a second substrate 21, a third substrate 51 facing the second substrate 21, and an ultraviolet absorbing layer 59a or 59b provided between the second substrate 21 and the third substrate 51. The second substrate 21 and the third substrate 51 respectively have transparent electrodes 35 and 55 provided thereon. The transparent electrodes 35 and 55 are formed of ITO or the like. The ultraviolet absorbing layer 59a or 59b is formed between the transparent electrode 35 and the transparent electrode 55. The transparent electrodes 35 and 55 each apply a voltage to the ultraviolet absorbing layer 59a or 59b.

The ultraviolet absorbing layer 59a is a guest-host (GH) liquid crystal layer containing an ultraviolet dichroic dye 70a1 or 70a2. The ultraviolet absorbing layer 59b is an electrowetting (EW) layer containing an ultraviolet absorbing colorant 01 or 02.

Regarding the GH liquid crystal layer, the ultraviolet dichroic dye 70a1 or 70a2 to be mixed in the liquid crystal material as a host merely needs to have absorption anisotropy for the ultraviolet rays, and may be, for example, an azo-based compound. The EW layer contains the ultraviolet absorbing colorant 01 or 02 mixed in a nonpolar solution such as silicone oil or the like. The ultraviolet absorbing colorant 01 or 02 is benzotriazole-based, benzophenone-based, benzoate-based or the like, and is, for example, Tinuvin 320 or Tinuvin P (both by Ciba Specialty Chemicals Kabushiki Kaisha). These ultraviolet absorbing layer 59a and 59b may be entirely driven instead of being controlled pixel-by-pixel, may be driven by an active element such as a TFT or the like located for each pixel, or may be driven passively by use of striped electrodes.

Now, the ultraviolet absorbing layer 102 will be described.

As shown in FIGS. 8(a) and 8(b), according to a GH liquid crystal layer system, a voltage is applied to the liquid crystal layer as a host to control the ultraviolet dichroic dye 70a1 or 70a2 as a guest. For example, a vertical alignment film (not shown) is formed on each of the transparent electrodes 35 and 55, an n-type liquid crystal display material is used as a host liquid crystal display material, and an ultraviolet dichroic dye having positive absorption anisotropy is used. As shown in FIG. 8(a), when no voltage is applied to the GH liquid crystal layer 59a, ultraviolet rays UV7 incident on the GH liquid crystal layer 59a are not absorbed by the ultraviolet dichroic dye 70a1. Therefore, the photochromic layer 22 is irradiated with the ultraviolet rays UV7. As a result, the photochromic layer 22 is put into a color-developed state, and thus color display is provided. As shown in FIG. 8(b), when a voltage is applied to the GH liquid crystal layer 59a, ultraviolet rays UV8 incident on the GH liquid crystal layer 59a are absorbed by the ultraviolet dichroic dye 70a2 as a guest. Therefore, the photochromic layer 22 is not irradiated with the ultraviolet rays UV8. As a result, the photochromic layer 22 is put into a color-disappeared state, and thus black-and-white display is provided.

Similarly, as shown in FIGS. 8(c) and 8(d), according to an EW system, a voltage is applied to the EW layer 59b to control the ultraviolet absorbing colorant 01 or 02. As shown in FIG. 8(c), when a voltage is applied to the EW layer 59b, the ultraviolet absorbing colorant 01 gathers to prescribed areas. As a result, in areas in the EW layer 59b other than the prescribed areas, the ultraviolet rays UV7 incident on the EW layer 59 are transmitted through the EW layer 59. Therefore, the photochromic layer 22 is irradiated with the ultraviolet rays UV7. As a result, the photochromic layer 22 is put into a color-developed state, and thus color display is provided. By contrast, as shown in FIG. 8(d), when no voltage is applied to the EW layer 59b, the ultraviolet absorbing colorant 02 spreads so as to cover all the pixels and absorb ultraviolet rays UV8. Therefore, the photochromic layer 22 is not irradiated with the ultraviolet rays UV8. As a result, the photochromic layer 22 is put into a color-disappeared state, and thus black-and-white display is provided.

Namely, by applying or not applying a voltage to the ultraviolet absorbing layer 59a or 59b, the ultraviolet rays incident on the ultraviolet absorbing layer 59a or 59b are controlled to be transmitted or not to be transmitted through the ultraviolet absorbing layer 59a or 59b. Thus, the display is switched between color display and black-and-white display.

The display device 100E provides the same effects as those of, for example, the display device 100C. The substrate of the ultraviolet modulating layer 102 may be formed of a resin (e.g., acrylic resin). In this case, the ultraviolet modulating layer 102 can be added to, for example, the display device 100A2, so as to produce the display device 100E easily.

Now, with reference to FIG. 9, a display device 100F in still another embodiment according to the present invention will be described. The display device 100F is a see-through-type liquid crystal display device.

The display device 100F includes an ultraviolet modulating layer 102 as described above in addition to the elements of the display device 100B. The ultraviolet modulating layer 102 is provided on the ultraviolet rays L1 incidence side. The ultraviolet modulating layer 102 is provided closer to the surface on which the ultraviolet rays L1 are incident than the photochromic layer 22 is.

The display device 100F provides the same effects as those of, for example, the display device 100D. As described above, the substrate of the ultraviolet modulating layer 102 may be formed of a resin (e.g., acrylic resin). In this case, the ultraviolet modulating layer 102 can be added to, for example, the display device 100B, so as to produce the display device 100F easily.

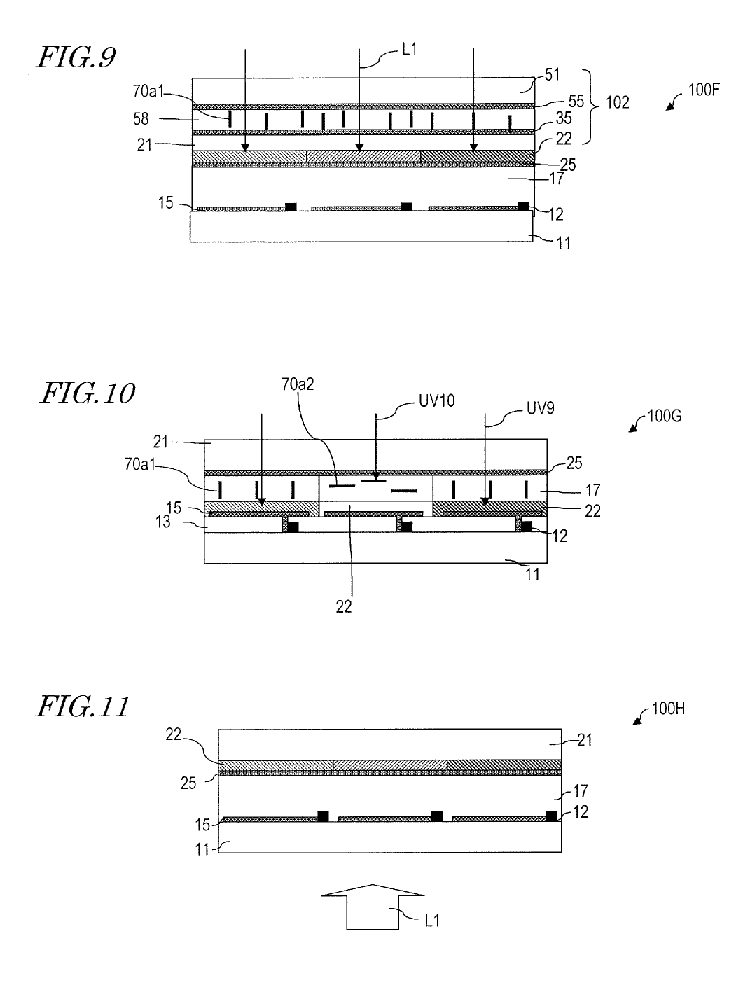

Now, with reference to FIG. 10, a display device 100G in still another embodiment according to the present invention will be described. The display device 100G is a reflection-type liquid crystal display device.

The display device 100G is different from the display device 100A2 in that the light modulating layer 17 is a GH liquid crystal layer. In the GH liquid crystal layer, the ultraviolet dichroic dye 70a1 or 70a2 is a guest colorant and the normal-mode PNLC or PDLC is a host liquid crystal material. Alternatively, the host liquid crystal material may be a reverse-mode PNLC or PDLC, or a liquid crystal layer containing liquid crystal molecules aligned uniformly in the absence of voltage. Still alternatively, as described above, a cholesteric liquid crystal material having a selective-reflection wavelength set to an infrared range and providing display by scattering or transmitting light may be used as a host liquid crystal material.

Ultraviolet dichroic dyes include a colorant having positive absorption anisotropy and a colorant having negative absorption anisotropy. In the case where the GH liquid crystal layer is a PNLC layer or a PDLC layer, usable combinations of the ultraviolet dichroic dye, the alignment film, the liquid crystal material and the polymer are as shown in Table 1.

TABLE 1

| PNLC or PDLC mode | Normal mode | Reverse mode | | |
|---|---|---|---|---|
| Alignment film | None, or | Vertical | Horizontal | Vertical |
| | horizontal | alignment film | alignment film | alignment film |
| | alignment film | | | |
| Liquid crystal | p-type | n-type | p-type | n-type |
| material | | | | |
| Polymer | No refractive | No refractive | Refractive | Refractive |
| | index | index | index | index |
| | anisotropy | anisotropy | anisotropy | anisotropy |
| Ultraviolet dichroic | Negative | Negative | Positive | Negative |
| dye | absorption | absorption | absorption | absorption |
| | anisotropy | anisotropy | anisotropy | anisotropy |

In the case where as a host liquid crystal material, a liquid crystal material containing liquid crystal molecules aligned uniformly in the absence of voltage is used, it is preferable that the ultraviolet dichroic dye has positive absorption anisotropy if positive or negative absorption anisotropy can be selected. In the case where a cholesteric liquid crystal material providing display by scattering or transmitting light is used, the ultraviolet dichroic dye preferably have negative absorption anisotropy.

Now, the display device 100G including the following GH liquid crystal layer as the light modulating layer 17 will be described: a horizontal alignment film is formed on the transparent electrodes 15 and also on the transparent electrode 25, a reverse-mode PDLC (PDLC having a p-type liquid crystal material and a polymer having absorption anisotropy) is used as a host liquid crystal material, and ultraviolet dichroic dyes 70a1 and 70a2 are provided as guest colorants.

As shown in FIG. 10, when a voltage is applied to the light modulating layer 17, the ultraviolet dichroic dye 70a1 in the light modulating layer 17 is aligned in a direction vertical to the substrates 11 and 21 along with the alignment of the liquid crystal molecules, and thus ultraviolet rays UV9 are not absorbed by the ultraviolet dichroic dye 70a1. In this case, the photochromic layer 22 is irradiated with the incident ultraviolet rays UV9 and thus is put into a color-developed state. By contrast, when the level of voltage to be applied is decreased, the light modulating layer 17 is put into a transparent state, and the ultraviolet dichroic dye 70a2 is aligned parallel to the substrates 11 and 21. As a result, the ultraviolet dichroic dye 70a2 absorbs ultraviolet rays UV10. In this case, the photochromic layer 22 is not irradiated with the incident ultraviolet rays UV10 and thus is put into a color-disappeared state.

The ultraviolet dichroic dyes 70a1 and 70a2 have ultraviolet absorption anisotropy between a direction of a longer axis and a direction of a shorter axis of the molecules. Therefore, the ultraviolet dichroic dyes 70a1 and 70a2 are aligned along with the alignment of the liquid crystal molecules. For this reason, when the alignment of the liquid crystal molecules is changed by application of a voltage, the alignment of each of the ultraviolet dichroic dyes 70a1 and 70a2 is also changed. Thus, the amount of ultraviolet rays absorbed by the ultraviolet dichroic dyes 70a1 and 70a2 can be controlled.

The display device 100G provides substantially the same effects as those of, for example, the display device 100C.

Now, with reference to FIG. 11, a display device 100H in still another embodiment according to the present invention will be described. The display device 100H is a see-through-type liquid crystal display device.

The display device 100H is different from the display device 100B in that the light modulating layer 17 of the display device 100G is used. Specifically, the light modulating layer 17 in the display device 100H is a GH liquid crystal layer using a reverse-mode PDLC (PDLC having a p-type liquid crystal material and a polymer having absorption anisotropy) as a host liquid crystal material and an ultraviolet dichroic dye having positive absorption anisotropy as a guest colorant.

The display device 100H provides substantially the same effects as those of, for example, the display device 100D.

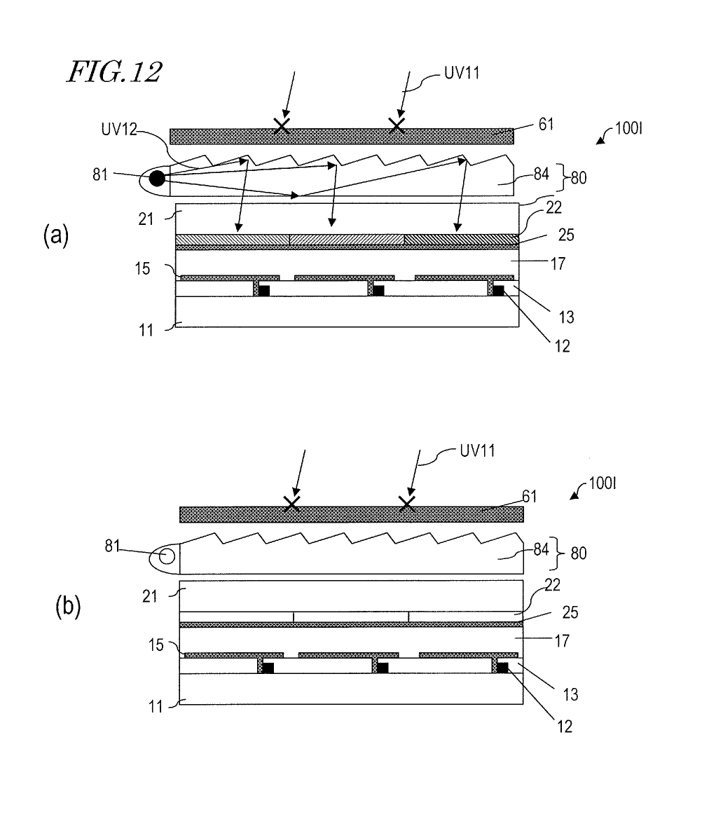

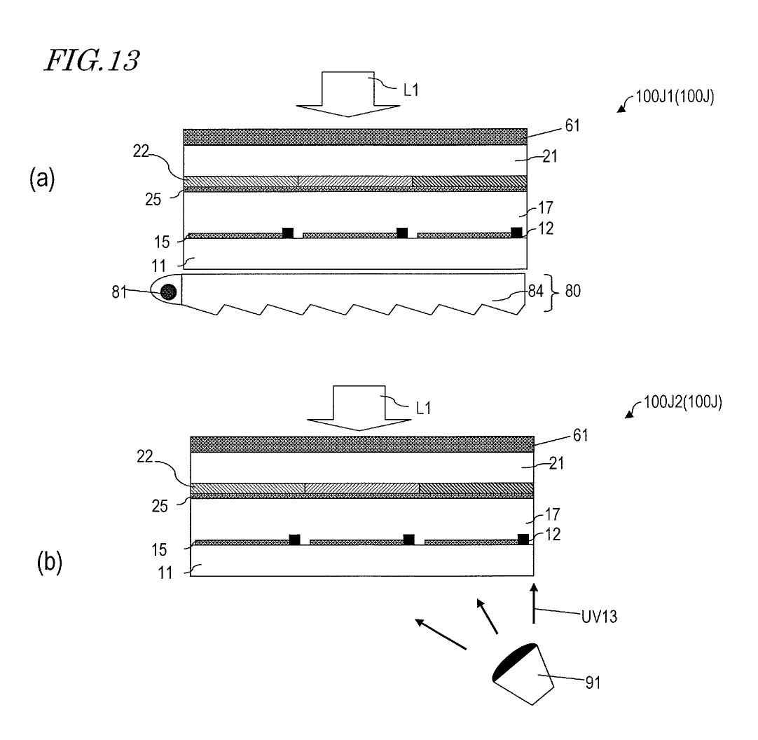

Now, with reference to FIGS. 12(a) and 12(b), a display device 100I in still another embodiment according to the present invention will be described. The display device 100I is a reflection-type liquid crystal display device.

The display device 100I includes an ultraviolet output layer 80 having a lightguide plate 84 in addition to the elements of the display device 100A2. The ultraviolet output layer 80 is provided on the light incidence side. The display device 100I further includes an ultraviolet absorbing plate 61 at an outermost surface on which the light is incident. The ultraviolet output layer 80 is located between the light modulating layer 17 and the ultraviolet absorbing plate 61. The ultraviolet output layer 80 is connected to an ultraviolet light source 81. Ultraviolet rays output from the ultraviolet output layer 80 are directed toward the photochromic layer 22.

The ultraviolet absorbing plate 61 may be any plate which absorbs ultraviolet rays UV11 contained in external light such as sunlight or the like so that the ultraviolet rays UV11 are not directed toward the photochromic layer 22. The ultraviolet absorbing plate 61 may be a resin plate containing an ultraviolet absorbing material, a glass plate having an ultraviolet absorbing film attached thereto, or a substrate (e.g., acrylic substrate or glass substrate) having a layer reflecting ultraviolet rays formed thereon. Any of these plates is located on the light incidence side (viewer side) of the photochromic layers 22. In the case where, for example, a display device of a mobile phone includes a panel protective plate, the panel protective plate may have such an ultraviolet absorbing function.

The ultraviolet light source 81 is, for example, an ultraviolet LED (Light Emitting Diode). The ultraviolet light source 81 may be a discharge tube filled with Xe. The ultraviolet light source 81 may be combined with a visible light source. A light source for emitting ultraviolet rays and visible light may be used. Such a light source and the lightguide plate 84 as shown in, for example, FIG. 12 may be combined to form a frontlight unit for irradiating the photochromic layer 22 with ultraviolet rays. Alternatively, the display panel itself of the display device 100I may be used as a lightguide plate for ultraviolet rays. The intensity of light from the light source (e.g., ultraviolet light source 81) may be adjustable. In the case where a plurality of light sources are provided, an area to be irradiated with the light sources may be divided.

Now, with reference to FIGS. 12(a) and 12(b), an operation of the display device 100I will be described.

In the case where external light does not contain ultraviolet rays, and even in the case where external light, such as sunlight, contains ultraviolet rays, the photochromic layer 22 is not irradiated with the ultraviolet rays UV11 contained in the external light. When the ultraviolet light source 81 is turned on, as shown in FIG. 12(a), ultraviolet rays UV12 pass the lightguide plate 84 and then are directed toward the photochromic layer 22. As a result, the photochromic layer 22 is put into a color-developed state, and color display can be provided. By contrast, when the ultraviolet light source 81 is turned off, the photochromic layer 22 is not irradiated with ultraviolet rays. As a result, the photochromic layer 22 is put into a color-disappeared state, and black-and-white display can be provided.

Regardless of the environment in which the display device 100I is used, when it is wished to display color display, the display device 100I can provide full-color display by putting the photochromic layer 22 into a color-developed state; and when color display is not needed but it is wished to provide display with a high light utilization factor, the display device 100I can provide display having a high brightness by putting the photochromic layer 22 into a color-disappeared state. In addition, by adjusting the intensity of light from the ultraviolet light source 81, the balance between the chroma and brightness can be adjusted. In the case where, for example, the pixel electrodes 15 reflect visible light, when it is wished to use the display device 100I as a mirror, the entirety of the photochromic layer 22 may be put into a color-disappeared state. In this case, the display device 100I can be used as a mirror having a high reflectance. Alternatively, a plurality of ultraviolet light sources 81 may be provided. In this case, by controlling the ultraviolet light sources 81 to be on or off, display can be provided with an area providing color display and an area providing display having a high brightness being distinguished.

Now, with reference to FIGS. 13(a) and 13(b), a display device 100J in still another embodiment according to the present invention will be described. The display device 100J is a see-through-type liquid crystal display device.

The display device 100J shown in FIG. 13(a) includes an ultraviolet output layer 80 having a lightguide plate 84 in addition to the elements of the display device 100B. The ultraviolet output layer 80 is provided on the side of the first substrate 11 opposite to the light modulating layer 17. The display device 100J also includes an ultraviolet absorbing plate 61 on the side of the second substrate 21 opposite to the light modulating layer 17. The ultraviolet absorbing plate 61 is located at an outermost surface of the display device 100J on the side on which the light L1 such as external light or the like is incident (viewer side). The photochromic layer 22 is provided between the ultraviolet absorbing plate and the ultraviolet output layer 80. Ultraviolet rays output from the ultraviolet output layer 80 are directed toward the photochromic layer 22. The ultraviolet output layer 80 is connected to an ultraviolet light source 81.

As the ultraviolet absorbing plate 61, any type of ultraviolet absorbing plate described above is usable. The second substrate 21 itself may have a function of absorbing ultraviolet rays.

As the ultraviolet light source 81 and the lightguide plate 84, any type of ultraviolet light source described above and the lightguide plate as described above are usable. The ultraviolet output layer 80 may be located as described above regarding the display device 100I to irradiate the photochromic layer 22 with ultraviolet rays. As shown in FIG. 13(b), the display device 100J may use an external UV source 91, instead of including the ultraviolet output layer 80, so that ultraviolet rays UV13 are directed toward the photochromic layer 22 from the side of the first substrate 11 of the display device 100I opposite to the light modulating layer 17.

When it is wished to display color display, the display device 100J can provide full-color display by putting the photochromic layer 22 into a color-developed state; and when color display is not needed but it is wished to provide display with a high light utilization factor, the display device 100J can provide display having a high brightness by putting the photochromic layer 22 into a color-disappeared state. In addition, by adjusting the intensity of light from the light source, the balance between the chroma and brightness can be adjusted. When it is wished to use the display device 100J as a transparent window, the entirety of the photochromic layer 22 may be put into a color-disappeared state. In this case, the display device 100J can be used as a window having a high transmittance. Alternatively, a plurality of light sources may be provided. In this case, by controlling the light sources to be on or off, display can be provided with an area providing color display and an area providing display having a high brightness being distinguished.

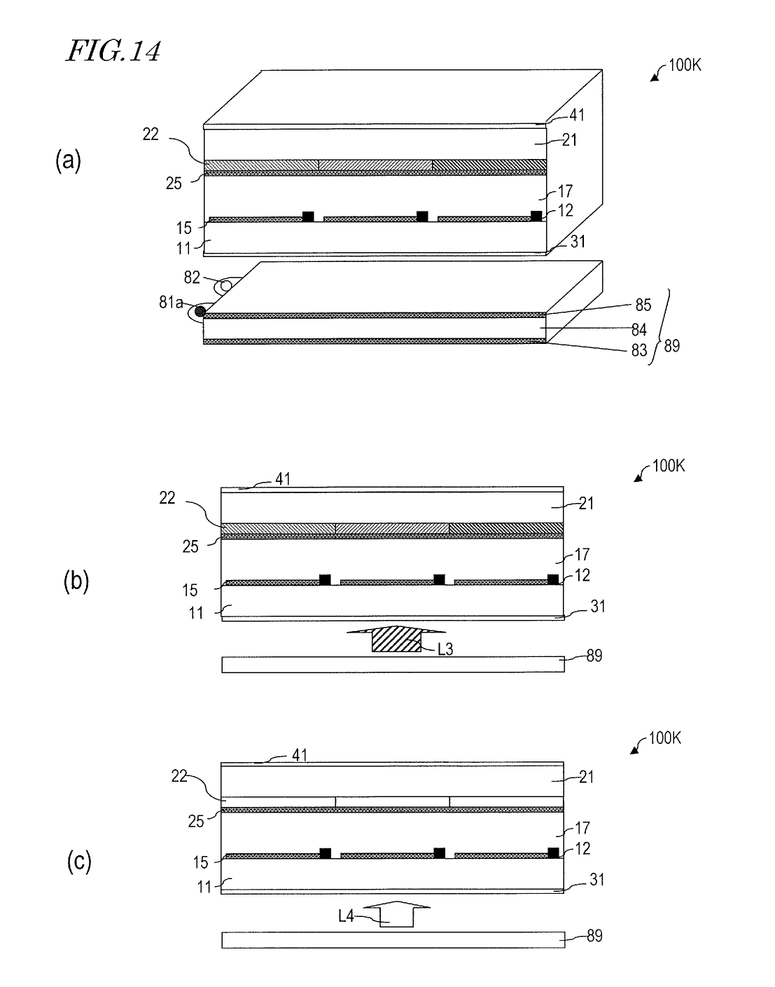

Now, with reference to FIG. 14, the display device 100K in still another embodiment according to the present invention will be described. The display device 100K is a transmission-type liquid crystal display device.

The display device 100K includes polarizing plates 31 and 41 in addition to the elements of the display device 100B. The polarizing plates 31 and 41 are respectively located on the side of the first substrate 11 and the second substrate 12 opposite to the light modulating layer 17. The display device 100K further includes a backlight unit 89 on the side of the polarizing plate 31 opposite to the first substrate 11. Ultraviolet rays emitted from the backlight unit 89 are directed toward the photochromic layer 22.

The light modulating layer 17 in the display device 100K contains liquid crystal molecules aligned uniformly in the absence of voltage.

The backlight unit 89 includes an ultraviolet LED 81a, a white LED 82 as a combination of a blue LED, a green phosphor and a red phosphor, a lightguide plate 84, a reflective sheet 83, and a diffusive sheet 85. The lightguide plate 84 is located between the reflective sheet 83 and the diffusive sheet 85. The ultraviolet LED 81a and the white LED 82 are located on a side surface of the lightguide plate 84. The lightguide plate 84 may be divided into a plurality of areas, which may be located separately. The light emitting intensity of each of the ultraviolet LED 81a and the white LED may be independently adjusted. The light sources of ultraviolet rays and white light are not limited to the LED light sources. Namely, the display device 100K merely needs to include a visible light source used to display an image or the like and an ultraviolet light source used to control the photochromic layer 22 as light sources.

When, for example, it is wished to control color display with no influence of external light, the display device 100K may include the ultraviolet absorbing plate 61 as the display device 100I. Alternatively, the polarizing plate 41 may have an ultraviolet absorbing function.

Now, with reference to FIGS. 14(b) and 14(c), the display device 100K will be described. FIGS. 14(b) and 14(c) are schematic cross-sectional views provided to describe an operation of the display device 100K.

As shown in FIG. 14(b), when it is wished to provide color display in, for example, indoors, the ultraviolet LED may be turned on. As a result, the photochromic layer 22 is irradiated with ultraviolet rays L3 and thus is put into a color-developed state. Thus, transmission-type color display can be provided. As shown in FIG. 14(c), when the ultraviolet LED is turned off, the photochromic layer 22 is not irradiated with ultraviolet rays (irradiated with only visible light). Therefore, the photochromic layer 22 is put into a color-disappeared state, and transmission-type monochromatic display is provided. When an ultraviolet absorbing plate 61 (not shown) is provided such that the photochromic layer 22 is formed between the ultraviolet absorbing plate 61 and the backlight unit 89, desired display can be provided by turning on or off the ultraviolet LED 81a regardless of the environment in which the display device 100K is used. The display device 100K may be altered to be a semi-transmission-type display device by a known method. In this case, the ultraviolet output layer 80 shown in FIG. 12 may be located on the side of the polarizing plate 41 opposite to the second substrate 21. In this case, the ultraviolet light source 81 may be combined with a visible light source, so that the ultraviolet output layer 80 acts as a frontlight unit.

When, for example, the display device 100K is used in a mobile terminal, a content such as a full-color moving image or photograph can be provided in color display; whereas an electronic book or the like, which does not need to be provided in color display, can be provided in monochromatic display having a high transmittance. In monochromatic display, visible light is not absorbed by the color filters. Therefore, the luminance of the backlight unit for emitting visible light can be reduced to decrease the power consumption for display. By adjusting the intensity of each of the light sources of visible light and ultraviolet rays, the balance between the chroma and brightness can be adjusted. In the case where a plurality of light sources are provided and are controlled to be on or off, display can be provided with an area providing color display and an area providing display having a high brightness being distinguished.

In the see-through-type display devices among the display devices 100A through 100K described above, a reflection-preventive film such as an AR (Anti Reflection) film, an LR (Low Reflection) film, a mosquito-eye film or the like may be located on at least one of outermost surfaces of each display device. In the transmission-type or reflection-type display devices, such a reflection-preventive film may be located on an outermost surface on the viewer side of each display device. By including such a reflection-preventive film, the display devices 100A through 100J can provide an improved mirror characteristic (characteristic which makes the viewer feel that he/she looks at a mirror) or transparency, and the display device 100K can provide display with little influence of the environment of use.

The display devices 100A through 100K described above may be combined in any way for use.

The display devices 100A through 100K described above each include the photochromic layer 22, and therefore have a higher transmittance and are produced at lower cost than, for example, the display device disclosed in Patent Document 1 including an electrochromic layer. Since the photochromic layer 22 is put into a color-developed state or a color-disappeared state by ultraviolet rays, neither a device nor power for driving the photochromic layer 22 is necessary. Thus, these display devices can be driven at low power consumption.

### INDUSTRIAL APPLICABILITY

A display device according to the present invention is preferably usable for various types of electronic devices such as mobile phones, pocket-size game devices, PDAs (Personal Digital Assistants), mobile TVs, remote controls, notebook personal computers, mobile terminals and the like. A display device according to the present invention is also preferably usable for a large display device for information display or digital signage, or as a substituted of a window.

### REFERENCE SIGNS LIST

11, 21 Substrate
12 Active element
13 Insulating layer
15, 25 Transparent electrode
17 Light modulating layer
22 Photochromic layer
100A, 100A1, 100A2, 100A2a, 100A2b, 100A2c Display device

1. A display device, comprising:
a first substrate, a second substrate, and a light modulating layer provided between the first substrate and the second substrate;
wherein the first substrate or the second substrate has a photochromic layer provided thereon containing a photochromic compound.

2. The display device of claim 1, wherein the light modulating layer is a liquid crystal layer.

3. The display device of claim 2, wherein the liquid crystal layer is a scattering-type liquid crystal layer.

4. The display device of claim 2, wherein the liquid crystal layer is a PNLC layer or a PDLC layer.

5. The display device of claim 2, wherein liquid crystal molecules contained in the liquid crystal layer are aligned uniformly in the absence of voltage.

6. The display device of claim 1, further comprising a first ultraviolet polarizing plate and a second ultraviolet polarizing plate located closer to a surface on which ultraviolet rays are incident than the first ultraviolet polarizing plate is;
wherein:
the light modulating layer is formed between the first ultraviolet polarizing plate and the second ultraviolet polarizing plate; and
the first ultraviolet polarizing plate is located closer to the surface on which the ultraviolet rays are incident than the photochromic layer is.

7. The display device of claim 6, further comprising:
a first λ/4 phase plate provided between the first ultraviolet polarizing plate and the light modulating layer; and
a second λ/4 phase plate provided between the second ultraviolet polarizing plate and the light modulating layer.

8. The display device of claim 1, further comprising an ultraviolet modulating layer located closer to a surface on which ultraviolet rays are incident than the photochromic layer is;
wherein:
the ultraviolet modulating layer includes a first ultraviolet polarizing plate, a second ultraviolet polarizing plate, and another liquid crystal layer formed between the first ultraviolet polarizing plate and the second ultraviolet polarizing plate; and
liquid crystal molecules contained in the another liquid crystal layer are aligned uniformly in the absence of voltage.

9. The display device of claim 8, further comprising:
a first λ/4 phase plate provided between the first ultraviolet polarizing plate and the another liquid crystal layer; and
a second λ/4 phase plate provided between the second ultraviolet polarizing plate and the another liquid crystal layer.

10. The display device of claim 1, further comprising an ultraviolet modulating layer located closer to a surface on which ultraviolet rays are incident than the photochromic layer is;
wherein:
the ultraviolet modulating layer includes an ultraviolet control layer; and
intensity of the ultraviolet rays transmitted through the ultraviolet control layer is controlled by application of a voltage to the ultraviolet control layer.

11. The display device of claim 10, wherein the ultraviolet control layer is formed of a guest-host liquid crystal material containing an ultraviolet dichroic dye.

12. The display device of claim 10, wherein the ultraviolet control layer is an electrowetting layer containing an ultraviolet absorbing colorant.

13. The display device of claim 1, wherein:
the light modulating layer is formed closer to a surface on which ultraviolet rays are incident than the photochromic layer is; and
the light modulating layer is formed of a guest-host liquid crystal material containing an ultraviolet dichroic dye.

14. The display device of claim 1, further comprising an ultraviolet absorbing plate and an ultraviolet output layer;
wherein:
the photochromic layer is formed between the ultraviolet absorbing plate and the ultraviolet output layer; and
ultraviolet rays which are output from the ultraviolet output layer are directed toward the photochromic layer.

15. The display device of claim 1, further comprising an ultraviolet absorbing plate and an ultraviolet output layer;
wherein:
the ultraviolet output layer is formed between the ultraviolet absorbing plate and the photochromic layer; and
ultraviolet rays which are output from the ultraviolet output layer are directed toward the photochromic layer.

16. The display device of claim 1, further comprising a backlight unit including an ultraviolet light source;
wherein ultraviolet rays which are emitted from the backlight unit are directed toward the photochromic layer.

17. The display device of claim 16, further comprising an ultraviolet absorbing layer;
wherein the photochromic layer is formed between the ultraviolet absorbing plate and the backlight unit.

18. The display device of claim 1, wherein:
the display device is a see-through-type display device; and
the first substrate and the second substrate both have a layer provided thereon containing the photochromic compound.

19. The display device of claim 1, further comprising a reflective film.

20. The display device of claim 1, further comprising a color filter layer;
wherein the photochromic layer is stacked on the color filter layer as seen in a direction normal to a display plane of the display device.
